(19) United States
(12) Patent Application Publication
(10) Pub. No.: US 2024/0235893 A9
(43) Pub. Date: Jul. 11, 2024

(54) Gateway for Facilitating Control System Upgrades

(71) Applicant: Fisher-Rosemount Systems, Inc., Round Rock, TX (US)

(72) Inventors: Aaron Crews, Round Rock, TX (US); Duncan Schleiss, Round Rock, TX (US); Nobin William, Round Rock, TX (US); Marc Troy, Round Rock, TX (US)

(21) Appl. No.: 18/480,036

(22) Filed: Oct. 3, 2023

Related U.S. Application Data
(60) Provisional application No. 63/418,350, filed on Oct. 21, 2022.

(51) Int. Cl. H04L 12/66; H04L 67/025; H04L 67/10

(52) U.S. Cl. CPC H04L 12/66; H04L 67/025; H04L 67/10

(57) ABSTRACT

Gateway devices, systems, and methods for facilitating control system upgrades including hosting a web application via a gateway device that permits configuration of the gateway device via a web browser. A redundant gateway system can be implemented such that both a primary gateway device and a secondary gateway device are used in conjunction. The web application can provide significant advantages in terms of ease of configurability and integration of legacy input/output (I/O) systems to facilitate control system upgrades in a variety of applications.

### CROSS-REFERENCE TO RELATED APPLICATION

The present application is based on and claims priority to U.S. Patent Application No. 63/418,350, filed on Oct. 21, 2022, the entire disclosure of which is incorporated herein by reference.

### BACKGROUND

The present disclosure relates generally to systems, methods, and devices that permit an existing distributed control system (DCS) to be upgraded while the input/output (I/O) system of the existing DCS is maintained. The distributed control system can be used to control various types of complex processes, such as complex processes for automotive manufacturing, chemical processing, oil and gas, food and beverage, medical manufacturing, water treatment, paper manufacturing, mining, metal processing, packaging, filling, and others.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements.

FIG. 1 is an illustration of an example input/output (I/O) system, in accordance with some aspects of the disclosure.

FIG. 2 is a diagram showing example components of a legacy distributed control system including the example input/output system of FIG. 1, in accordance with some aspects of the disclosure.

FIG. 3 is a diagram showing example components of an upgraded distributed control system that can be connected to the example input/output system of FIG. 1, in accordance with some aspects of the disclosure.

FIG. 4 is a perspective illustration of an example gateway device that can be used in the upgraded distributed control system of FIG. 3, in accordance with some aspects of the disclosure.

FIG. 5 is a block diagram showing example components of the example gateway device of FIG. 4, in accordance with some aspects of the disclosure.

FIG. 6 is an illustration showing an example login interface that can be provided by the example gateway system of FIG. 3, in accordance with some aspects of the disclosure.

FIG. 7 is an illustration showing an example general gateway configuration interface that can be provided by the example gateway system of FIG. 3, in accordance with some aspects of the disclosure.

FIG. 8 is an illustration showing an example Ethernet configuration interface that can be provided by the example gateway system of FIG. 3, in accordance with some aspects of the disclosure.

FIG. 9 is an illustration showing an example gateway system configuration interface that can be provided by the example gateway system of FIG. 3, in accordance with some aspects of the disclosure.

FIG. 10 is an illustration showing an example input/output file configuration interface that can be provided by the example gateway system of FIG. 3, in accordance with some aspects of the disclosure.

FIG. 11 is an illustration showing an example input/output card configuration interface that can be provided by the example gateway system of FIG. 3, in accordance with some aspects of the disclosure.

FIG. 12 is an illustration showing another example input/output card configuration interface that can be provided by the example gateway system of FIG. 3, in accordance with some aspects of the disclosure.

FIG. 13 is an illustration showing an example input/output card cloning interface that can be provided by the example gateway system of FIG. 3, in accordance with some aspects of the disclosure.

FIG. 14 is an illustration showing an example input/output card reassignment interface that can be provided by the example gateway system of FIG. 3, in accordance with some aspects of the disclosure.

FIG. 15 is an illustration showing another example input/output card reassignment interface that can be provided by the example gateway system of FIG. 3, in accordance with some aspects of the disclosure.

FIG. 16 is an illustration showing an example input/out configuration overview interface that can be provided by the example gateway system of FIG. 3, in accordance with some aspects of the disclosure.

FIG. 17 is an illustration showing an example gateway status diagnostics interface that can be provided by the example gateway system of FIG. 3, in accordance with some aspects of the disclosure.

FIG. 18 is an illustration showing an example gateway statistics diagnostics interface that can be provided by the example gateway system of FIG. 3, in accordance with some aspects of the disclosure.

FIG. 19 is an illustration showing an example input/output card information diagnostics interface that can be provided by the example gateway system of FIG. 3, in accordance with some aspects of the disclosure.

FIG. 20 is an illustration showing an example input/output card status diagnostics interface that can be provided by the example gateway system of FIG. 3, in accordance with some aspects of the disclosure.

FIG. 21 is an illustration showing an example input/output card control diagnostics interface that can be provided by the example gateway system of FIG. 3, in accordance with some aspects of the disclosure.

FIG. 22 is a flow diagram illustrating an example process for integrating the input/output system of FIG. 1 into the upgraded distributed control system of FIG. 3, in accordance with some aspects of the disclosure.

### DETAILED DESCRIPTION

Distributed control systems for various types of complex processes (e.g., automotive manufacturing, chemical processing, oil and gas, food and beverage, medical manufacturing, water treatment, paper manufacturing, mining, metal processing, packaging, filling, etc.) rely on various electrical devices and systems for proper process monitoring and control. Given the complex nature of these types of control systems, it can be difficult to update various equipment included in the control system without incurring significant costs and labor efforts. Systems, methods, and devices that could be used to facilitate transitions between older equipment and newer equipment without requiring replacement of all equipment in the system and without requiring significant investment in terms of capital and labor are generally desired in the field.

A typical distributed control system may interface with several hundred to several thousand field devices such as transmitters, thermocouples, and switches that provide an indication of various process conditions; solenoids and digital valve controllers that control the operation of valves; lights or other indicators that provide a field indication of process conditions; and other types of process inputs and outputs. These field devices may be spread over very large physical areas, and the majority of the field devices can communicate with the distributed control system via wires that form individual circuits between the distributed control system and each field device (e.g., a pair of wires that convey an analog signal via the current flowing on the circuit, an open or closed circuit that indicates the status of a process parameter or causes a process control device to be in a particular state, etc.). The wires that connect the hundreds or thousands of field devices to the distributed control system may be routed through a series of field wiring, junction boxes, and homerun cables to various marshalling locations (e.g., marshalling cabinets) at which the wires that are coupled to individual field devices are “marshalled” so that they may be connected to the desired input/output interface (e.g., I/O cards) of the distributed control system.

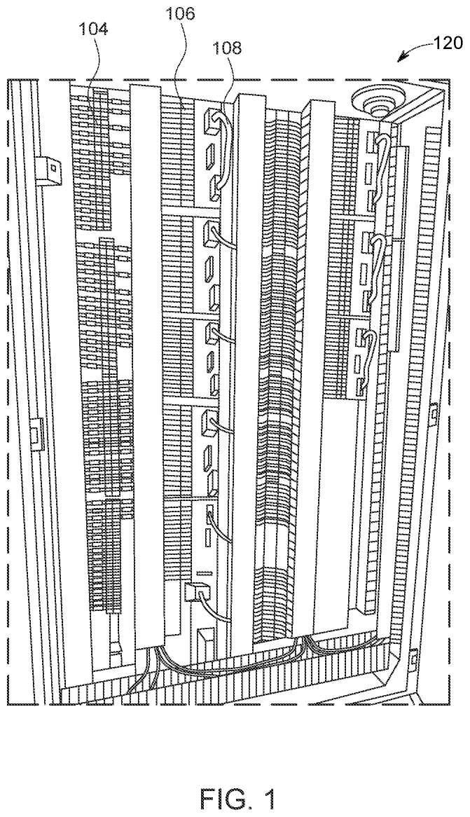

Referring to FIG. 1, an illustration showing example components of an input/output system 120 is shown, in accordance with some aspects of the disclosure. In the input/output system 120, as shown, field wiring (e.g., wires coming from a field junction box in a homerun cable that includes multiple pairs of wires) is landed on a first side of one of a terminal block 104 included in the input/output system 120 (e.g., in an electrical panel, such as a marshalling cabinet). Individual pairs of wires are then routed from the other side of the terminal block 104 to a field termination assembly (FTA) 106. The field termination assembly 106 can be unique to the vendor of the distributed control system and/or the input/output system 120, can be specific to a particular type of input/output interface (e.g., a specific type of I/O card), and/or can be coupled to a single input/output interface via a multi-conductor cable connected between the field termination assembly 106 and the input/output interface.

For example, the field termination assembly 106 can be associated with an eight-channel analog input/output card that receives eight separate analog input signals (e.g., from eight different field devices), and can include terminals to receive the individual wires associated with those eight separate analog inputs via a cable 108 of the input/output system 120, as shown in FIG. 1, to carry those eight signals from the field termination assembly 106 to the input/output card. Similarly, the field termination assembly 106 can be associated with a 16-channel digital input/output card, a 32-channel input/output card, etc. In such an example where the field termination assembly 106 is associated with a 16-channel digital input/output card, the field termination assembly 106 can include terminals to receive the individual wires associated with those 16 separate digital inputs, and the cable 108 can carry those signals from the field termination assembly 106 to the respective input/output card.

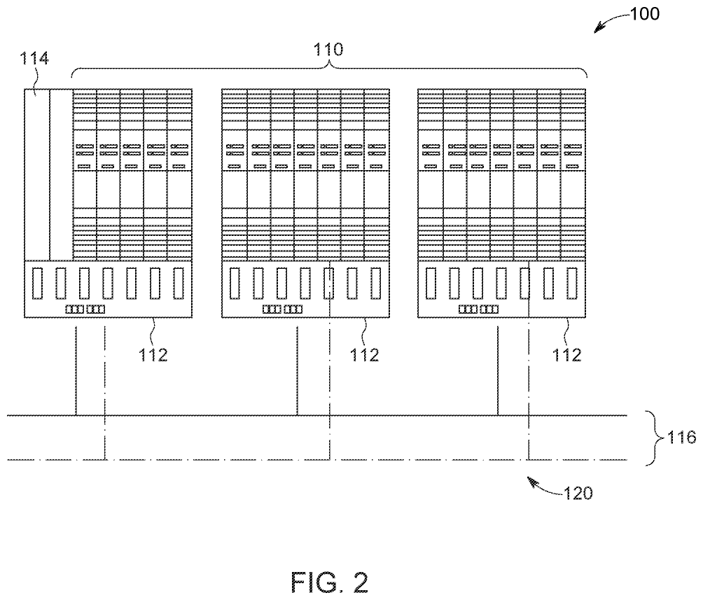

Referring to FIG. 2, a diagram showing example components of a legacy distributed control system 100 including the input/output system 120 is shown, in accordance with some aspects of the disclosure. Specifically, FIG. 2 shows further aspects of the input/output system 120 of the legacy distributed control system 100, where the input/output system 120 further includes multiple input/output cards 110. One or more of the input/output cards 110 shown in FIG. 2 can be connected to the field termination assembly 106, for example. The input/output cards 110 can receive the cable 108 carrying signals from field devices (e.g., eight analog input signals, sixteen digital input signals, etc.) from the individual wires that are landed on the terminal block 104, routed to the field termination assembly 106, and then routed to one or more of the input/output cards 110 via the cable 108. As shown in FIG. 2, the input/output cards 110 can each be mounted in a respective chassis 112. The input/output cards 110 can be separate, rectangular box-shaped devices disposed within a given chassis 112, among other possible implementations of input/output interfaces used in the legacy distributed control system 100. The input/output cards 110 can then communicate with a controller 114 that executes control strategies for the legacy distributed control system 100 and is also disposed in one of the chassis 112 via a communication bus 116 that is disposed along a backplane of the chassis 112 and/or between the chassis 112. The communication bus 116 can include multiple, separate redundant busses, in some examples. In the input/output system 120, the chassis 112 can be connected to each other through additional serial busses, such as via coaxial cables. The legacy distributed control system 100 can include additional nodes beyond the input/output system 120 as well, and these additional nodes can be connected to the input/output system 120 through various network communications protocols including via a Universal Control Network (UCN) and/or a Local Control Network (LCN). When upgrading to the distributed control system 200 as detailed below (e.g., using the gateway system 202), much of this equipment including the legacy controller and network equipment (e.g., the controller 114, the coaxial cables, the networking equipment for the UCN and/or LCN network, etc.) can be disposed of such that it is no longer needed in the upgraded distributed control system 200.

While it may be desirable to upgrade the legacy distributed control system 100 to a more modern system with advanced capabilities (e.g., a system provided by a different vendor that is faster, more secure, and provides more dynamic control functionality), it may be difficult to upgrade the legacy distributed control system 100 without replacing the legacy distributed control system 100 entirely. This difficulty arises in part due to the fact that the legacy distributed control system 100 may be integrally linked with the field devices in the legacy distributed control system 100 due to the system and vendor specific nature of the input/output cards and the field termination assemblies (e.g., the field termination assembly 106). To replace the input/output cards and the field termination assemblies in the legacy distributed control system, significant rewiring of thousands of field devices to new input/output cards may be required. This cost in terms of capital and labor related to upgrading the input/output portion of the legacy distributed control system 100 can represent a significant portion of the cost of the overall system upgrade, and can make such an upgrade cost prohibitive. Moreover, if a vendor of the legacy distributed control system 100 ends support for certain components of the legacy distributed control system 100 (e.g., the controller 114), the user of the legacy distributed control system 100 may be forced to upgrade the entire legacy distributed control system 100, including a costly replacement and associated rewiring of the input/output system 120.

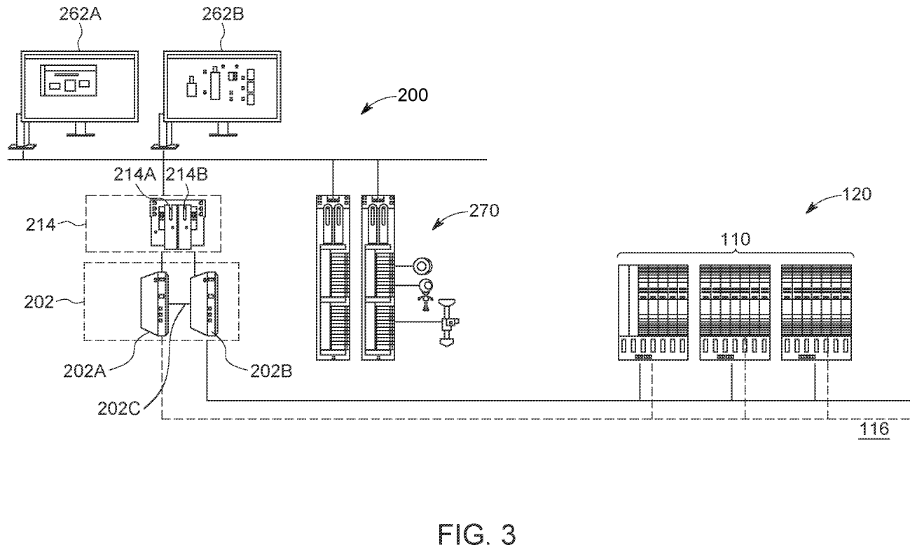

Referring to FIG. 3, a diagram showing example components of an upgraded distributed control system 200 that can be connected to the input/output system 120 is shown, in accordance with some aspects of the disclosure. The upgraded distributed control system 200 provides a more modern, advanced distributed control system relative to the legacy distributed control system 100. However, the upgraded distributed control system 200 is connected to the input/output system 120 of the legacy distributed control system 100 via a gateway system 202 to leverage the existing wiring and equipment of the input/output system 120. Accordingly, by using the gateway system 202, the more modern, updated distributed control system 200 can be implemented in a given application (e.g., a given manufacturing plant) without requiring the extensive costs and labor that would otherwise be required if the input/output system 120 was replaced entirely.

The gateway system 202 therefore can serve as a bridge between the input/output system 120 of the legacy distributed control system 100 (e.g., an existing, older system that has been installed at a plant for some time) and the distributed control system 200 (e.g., a newer, upgraded system for the plant). The upgraded distributed control system 200 is also shown to include a controller system 214 that is connected to and in communication with the gateway system 202, as well as example workstations 262A, 262B and equipment 270 that are connected to and in communication with the controller system 214. The workstations 262A, 262B can be implemented using any suitable computing devices, and can be used to perform various monitoring and control functions via the upgraded distributed control system 200 via a user interface. The equipment 270 can include any suitable types and combinations of equipment, including upgraded input/output systems and devices, that can be managed and controlled by the controller system 214 and the upgraded distributed control system 200 more generally. Notably, the gateway system 202 can serve as a bridge between the input/output system 120 and the upgraded control system 200 even if the upgraded control system 200 is provided by a different vendor than the input/output system 120. In some previous approaches, such a bridge may be limited to certain vendor systems with closed communications protocols.

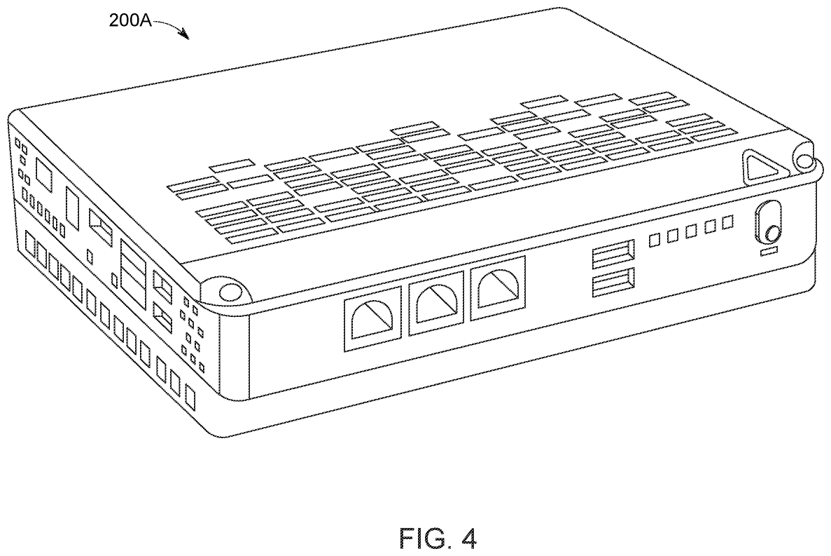

As shown in FIG. 3, the gateway system 202 can include both a primary gateway device 202A and a redundant secondary gateway device 202B. The primary gateway device 202A and the secondary gateway device 202B can be connected to and configured to communicate with each redundant bus of the communication bus 116, respectively. Additionally, the controller system 214 is shown to include both a primary controller device 214A and a redundant secondary controller device 214B that can be connected to and configured to communicate with the primary gateway device 202A and the secondary gateway device 202B, respectively. The gateway system 202 can communicate all necessary data generated by the input/output system 120 of the legacy distributed control system 100 to the controller system 214 such that the new, upgraded distributed control system 200 can use the data generated by the input/output system 120 of the legacy distributed control system 100 for process monitoring and control capabilities. The gateway system 202 is further shown to include a redundant communications link 202C that is established between the primary gateway device 202A and the secondary gateway device 202B for redundant communications. The redundant communication link 202C can be used to establish and maintain database synchronization communications between the primary gateway device 202A and the secondary gateway device 202B. This feature allows users to replace a broken gateway device with a new, replacement gateway device and automatically establish the new gateway device as a backup via the redundant communication link 202C. Referring to FIG. 4, a perspective illustration of the example primary gateway device 202A is shown, in accordance with some aspects of the disclosure. The perspective illustration shown in FIG. 4 is intended to provide an example that helps the reader better understand the present disclosure, but is not intended to be limiting in scope in any way.

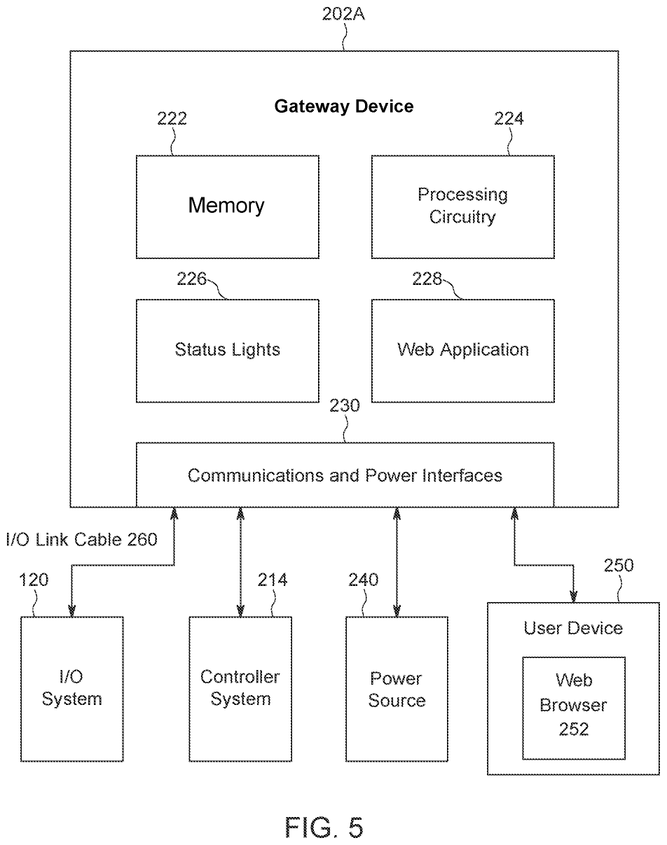

Referring to FIG. 5, a block diagram showing example components of the example primary gateway device 202A is shown, in accordance with some aspects of the disclosure. As shown, the primary gateway device 202A can include memory 222, processing circuitry 224, status lights 226, and a web application 228. The secondary gateway device 202B can be the same as or similar to the primary gateway device 202A, and it will be appreciated that the secondary gateway device 202B can include the same or similar example components as the primary gateway device 202A as shown in FIG. 5. The primary gateway device 202A is also shown to include a plurality of communications and power interfaces 230 that can be used to establish electrical connections with the input/output system 120, the controller system 214, a power source 240, and a user device 250 that executes a web browser 252.

It will be appreciated that, in some implementations, the gateway system 202 can include just the primary gateway device 202A in a simplex configuration, such that the redundant secondary gateway device 202B is not necessarily needed to implement various aspects of the disclosure. Similarly, in some implementations, the controller system 214 can include just the primary controller device 214A in a simplex configuration, such that the redundant secondary controller device 214B may not be needed to implement various aspects of the disclosure. As detailed below, the example components of the primary gateway device 202A as shown in FIG. 5 and the associated functionality can provide the gateway system 202 with a variety of features that facilitate simplicity and efficiency with respect to installing and configuring the gateway system 202. As such, various types of processing facilities can use the gateway system 202 to facilitate a control system upgrade at lower cost and improved efficiency relative to previous approaches.

The memory 222 can include any suitable storage device or devices that can be used to store machine-readable instructions, values, etc., that can be used, for example, by the processing circuitry 224 to implement various functions of the primary gateway device 202A. The memory 222 can include any suitable types of memory including volatile memory, non-volatile memory, and/or suitable combinations thereof. For example, the memory 222 can include random-access memory (RAM), dynamic random-access memory (DRAM), read-only memory (ROM), electrically erasable programmable read-only memory (EEPROM), one or more flash drives, one or more hard disks, one or more solid state drives, one or more optical drives, and/or other suitable types of memory. The memory 222 can include non-transitory computer readable storage media having instructions stored thereon for execution by the processing circuitry 224 to implement various functions of the primary gateway device 202A. The processing circuitry 224 can be implemented using any suitable hardware processor or combination of hardware processors, including using central processing units (CPU), graphics processing units (GPU), and/or other types of hardware processing components. The processing circuitry 224 can further be implemented using a suitable number of processing cores, including single core processors, dual core processors, and other processor core configurations. The processing circuitry 224 can generally execute machine-readable instructions to implement various functions of the primary gateway device 201A.

The status lights 226 can be used to communicate various information about the operation of the primary gateway device 202A to users of the primary gateway device 202A. For example, the status lights can be implemented using a collection of light-emitting diodes (LEDs) visible through a housing of the primary gateway device. The status lights 226 can include a power light that illuminates with a green color when all power rails associated with the primary gateway device 202A, illuminates with a yellow color when the standby power is valid, and illuminates with a red color when there is an error condition associated with the power supplied to the primary gateway device 202A (e.g., via the power source 240). The status lights 226 can further include a serial advanced technology attachment (SATA) light that illuminates with a green color when a SATA data access process is in progress (e.g., accessing data from the input/output system 120). The status lights 226 can further include a user light that illuminates with a solid green color when the primary gateway device 202A is in active mode and illuminates with a flashing green color (e.g., in one second intervals) to indicate that the primary gateway device 202A is in standby mode.

The status lights 226 can further include a temperature light that illuminates with a green color when a temperature associated with the primary gateway device 202A is below both a first threshold (e.g., a T_{HOT} threshold) and a higher, second threshold (e.g., a critical temperature T_{CRIT} threshold), illuminates with a yellow color when the temperature associated with the primary gateway device 202A is above the first threshold but below the second threshold, and illuminates with a read color when the temperature associated with the primary gateway device 202A is above both the first threshold and the second threshold. The status lights 226 can further include a trusted platform module (TPM) status light that illuminates with a red color or a green color indicative of the status of a physical presence state associated with the primary gateway device 202A when physical presence is activated on the primary gateway device 202A.

The web application 228 can include any suitable instructions stored in the memory 222 configured to provide one or web pages to the web browser 252 running on the user device 250 such that the web pages can be used to configure a variety of parameters associated with the primary gateway device 202A. For example, the web application 228 (e.g., via execution thereof by the processing circuitry 224) can serve as a web server that provides files (e.g., hypertext transfer protocol (HTTP) files) to the web browser 252 when the web browser access one or more web pages provided by the web application 228 (e.g., via one or more uniform resource locators (URLs)). Accordingly, a user of the user device 250 can easily and efficiently configure various parameters associated with the primary gateway device 202A via various user interfaces presented by the web browser 252 via the user device 250. The user device 250 can be implemented using any suitable computing device such as a smartphone, a desktop computer, a notebook computer, a laptop computer, a tablet, a wearable device, a workstation, a suitable human-machine interface (HMI) in a processing facility, and any other suitable types of computing devices. Similarly, the web browser 252 can be implemented using any suitable type of web browser that can be run on the user device 250.

The communications and power interfaces 230 can include any suitable communications and/or power interfaces such as ports, cables, wiring, antennas, wireless communications circuits, and/or other interfaces for establishing communications and power connections between the primary gateway device 202A and one or more external systems and/or devices. For example, the communications and power interfaces 230 can include a three pin power port for receiving 24 V DC power from the power source 240, among other possible implementations of power ports. The power source 240 can be any suitable source of power provided within a processing facility. In some implementations, the power source 240 can be and/or can include one or more internal batteries of the primary gateway device 202A. The power source 240 can also be and/or can include power from existing control system power supplies, including power supplies associated with the equipment 270, for example. A special type of cable can be designed to facilitate this transfer of power between the equipment 270 and the gateway system 202. The communications and power interfaces 230 can further include one or more Ethernet ports for connecting one or more Ethernet cables, including both primary Ethernet ports and potentially redundant Ethernet ports. The communications and power interfaces 230 can include a redundant Ethernet port that is used to connect the primary gateway device 202A to the redundant secondary gateway device 202B such that the primary gateway device 202A and the redundant secondary gateway device 202B can communicate status information between each other.

Further, the communications and power interfaces 230 can include a main Ethernet port for establishing a connection between the primary gateway device 202A and the controller system 214 (e.g., via the primary controller device 214A). The communications and power interfaces 230 can also include one or more serial communications ports for establishing a connection between the primary gateway device 202A and the input/output system 120 of the legacy distributed control system 100. As shown in FIG. 5, this connection between the primary gateway device 202A and the input/output system 120 of the legacy distributed control system 100 can be established using a particular type of input/output link cable 260.

The input/output link cable 260 can specifically be designed to include various features that facilitate operation of the primary gateway device 202A in terms of providing data from the input/output system 120 of the legacy distributed control system 100 to the controller system 214. The input/output link cable 260 can include a 5-pin male serial connector, where a resistor is installed between the first and second pins (e.g., a 125-ohm resistor), and the resistor may be required to operator the primary gateway device 202A in a normal operating mode. Moreover, the first pin of the 5-pin male serial connector of the input/output link cable 260 can be looped back to the fifth pin, the second pin can be looped back to the fourth pin, and the third pin can be a shielded ground pin. The 5-pin male serial connector of the input/output link cable 260 can then be connected to a female serial port of the communications and power interfaces 230 to connect the primary gateway device 202A to the input/output system 120 of the legacy distributed control system 100.

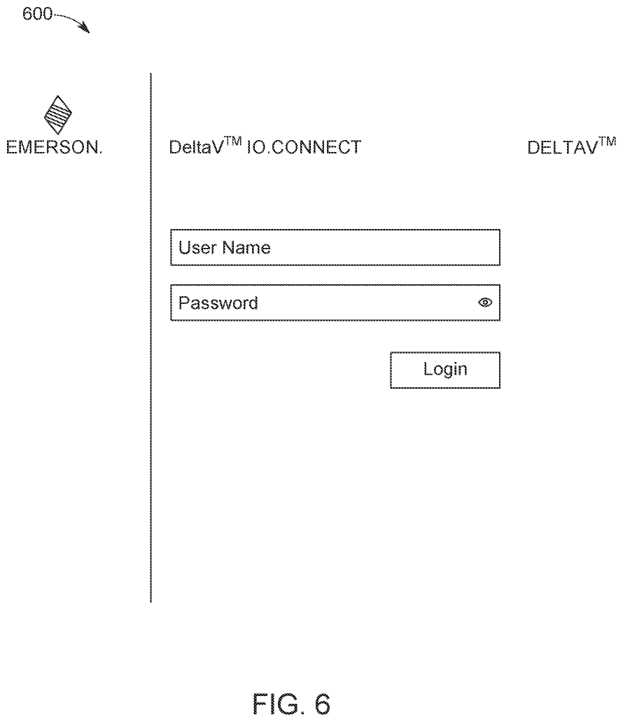

As noted, the web application 228 of the primary gateway device 202A can provide web pages to the web browser 252 of the user device 250 to facilitate simple and efficient configuration of the primary gateway device 202A and the gateway system 202 more generally. FIGS. 6-21 as detailed below illustrate various aspects of a web interface provided by the gateway system 202 (e.g., via the web application 228) for configuring the gateway system 202 via the web browser 252. In some implementations, one or more files native to the input/output system 120 of the legacy distributed control system 100 (e.g., .EB files) can be read from the input/output system 120 and converted to configuration files (e.g., .XML files) that define various parameters associated with the input/output system 120 of the legacy distributed control system 100. In some implementations, this conversion of files can be performed by a cloud computing application that executes instructions for automatically mapping various parameters associated with the input/output system 120 of the legacy distributed control system 100 (e.g., inputs, outputs, field devices, status information, data resolution, locations of the input/output cards 110 within the chassis 112, control algorithms maintained by the controller 114, etc.) to parameters that can be automatically understood and recognized by the gateway system 202. The conversion of files can also be performed by the gateway system 202 itself, and/or by an administrative computer.

Accordingly, a user of the user device 250 can provide the files native to the input/output system 120 of the legacy distributed control system 100 (e.g., .EB files) to the cloud computing application (e.g., via the web browser 252), and can receive a configuration file (e.g., .XML file) for the gateway system 202 as output from the cloud computing application. Then, via the web browser 252, the user can access the gateway system 202 via the web application 228 and download the configuration file to the gateway system 202. Upon downloading this configuration file to the gateway system 202, the user can then view and manage a variety of data and parameters associated with the gateway system 202 via the web browser 252, as will be detailed further below with respect to FIGS. 6-21. This functionality provided by the web application 228 can provide significant improvements in terms of facilitating control system upgrades due to the ease of use characteristics of the gateway system 202.

Additionally, upon finalizing a configuration of the gateway system 202 via the web browser 252, a control configuration file (e.g., .FHX file) generated by the gateway system 202 and/or the web browser 252 can be accessed and provided to the controller system 214 such that the controller system 214 can use the control configuration file to integrate the input/output system 120 of the legacy distributed control system 100 into the upgraded distributed control system 200. The control configuration file can include one or more physical device tags (PDTs) for each of the input/output cards 110 as well as a special field (e.g., a Boolean field) for each of the input/output cards 110 indicative of whether each of the input/output cards 110 are legacy input/output cards or not. This special field added to the control configuration file can provide a variety of advantages for facilitating control system upgrades, including providing the ability to monitor the progress of the broader control system upgrade process as well as the ability to provide the gateway system 202 on a subscription basis based on the number of legacy input/output cards 110 that are integrated into the upgraded distributed control system 200.

Referring to FIG. 6, an illustration of an example login interface 600 that can be provided by the gateway system 202 to the web browser 252 via the web application 228 is shown, in accordance with some aspects of the disclosure. As shown, the login interface 600 can include fields for entering a username and a password to login to the gateway system 202 via the web browser 252. The username and the password can provide a layer of cybersecurity protection such that not just anyone can access the gateway system 202 via the web browser 252, but rather only authorized individuals can access the gateway system 202 via the web browser 252. As will be detailed below, the username and password used to login to the gateway system 202 via the web browser 252 can be changed via the web browser 252 as appropriate.

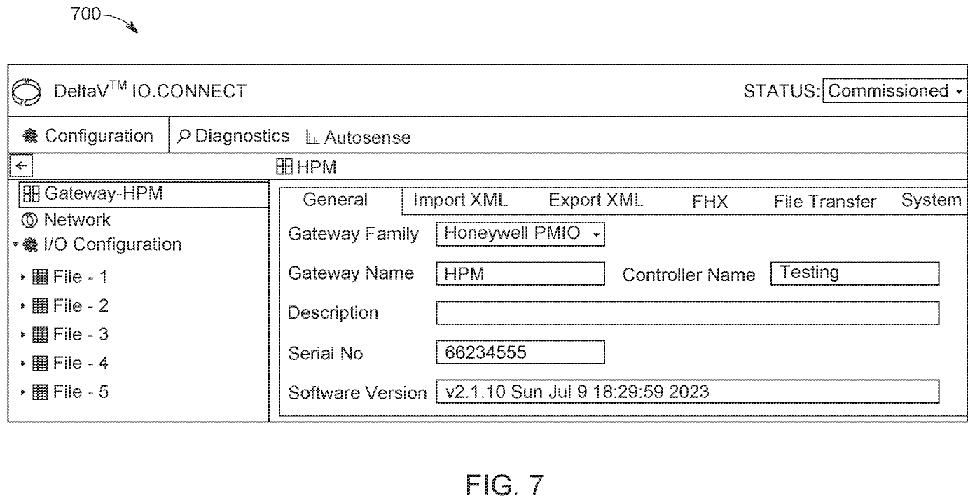

Referring to FIG. 7, an illustration of an example general gateway configuration interface 700 that can be provided by the gateway system 202 to the web browser 252 via the web application 228 is shown, in accordance with some aspects of the disclosure. As shown, the general gateway configuration interface 700 can be used to configure and view various parameters associated with the gateway system 202 including selecting a gateway family (e.g., a family associated with a vendor of the input/output system 120 of the legacy distributed control system 100), viewing and/or editing a name for the gateway system 202, viewing and/or editing a name for the controller system 214, viewing and/or editing a description of the gateway system 202, viewing a serial number associated with the gateway system 202, and viewing a current software version installed on the gateway system 202.

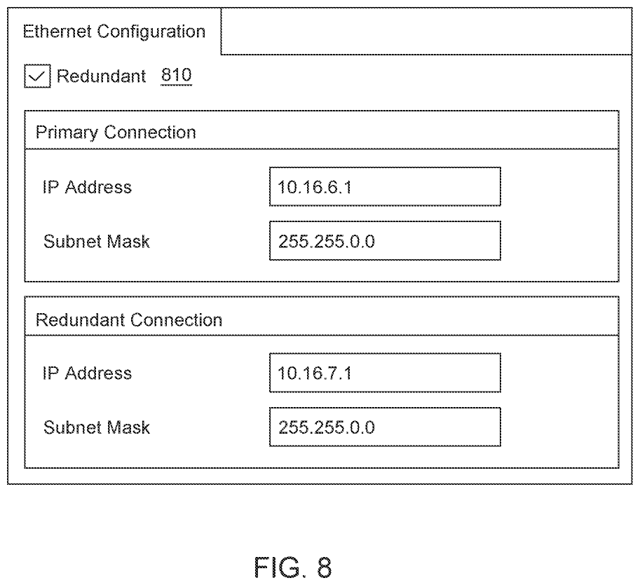

Referring to FIG. 8, an illustration of an Ethernet configuration interface 800 that can be provided by the gateway system 202 to the web browser 252 via the web application 228 is shown, in accordance with some aspects of the disclosure. As shown, the Ethernet configuration interface 800 can be used to configure network parameters associated with the primary gateway device 202A and the secondary gateway device 202B. Specifically, the Ethernet configuration interface 800 can be used to configure a primary connection Internet Protocol (IP) address and subnet mask, as well as a redundant connection IP address and subnet mask. The primary connection can be associated with the primary gateway device 202A, and the redundant connection can be associated with the secondary gateway device 202B, for example. In some examples, the third octet of the redundant connection IP address can be required to be set with a +1 value relative to primary connection IP address, as shown, to accommodate redundancy requirements and/or functionality of the upgraded distributed control system 200 and/or the controller system 214. The Ethernet configuration interface 800 is also shown to include a selectable user interface element 810 that can be selected and deselected depending on whether the gateway system 202 includes both the primary gateway device 202A and the secondary gateway device 202B or just the primary gateway device 202A.

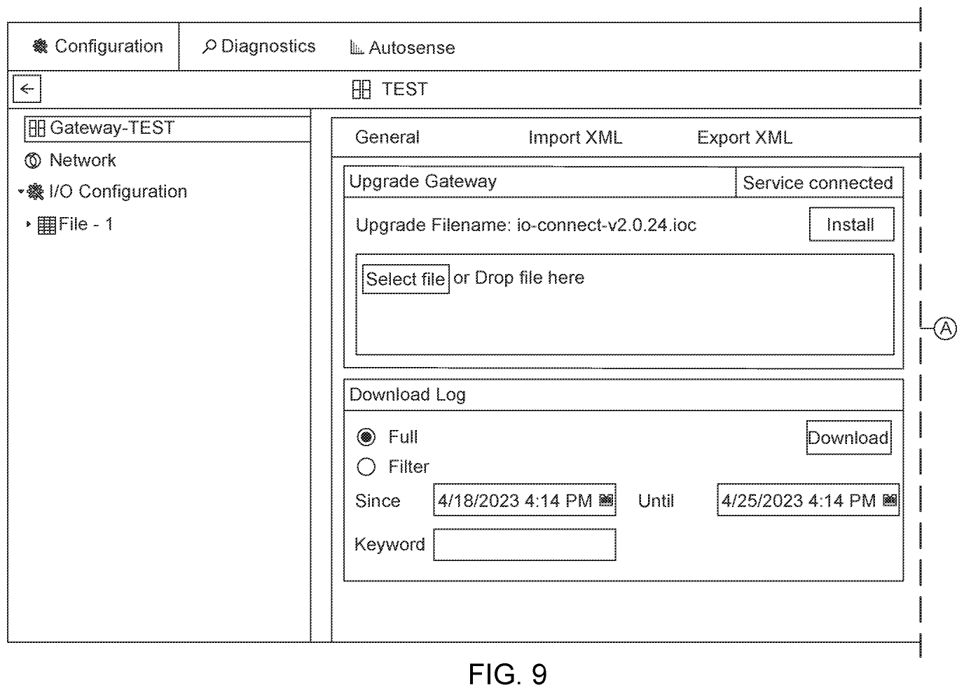

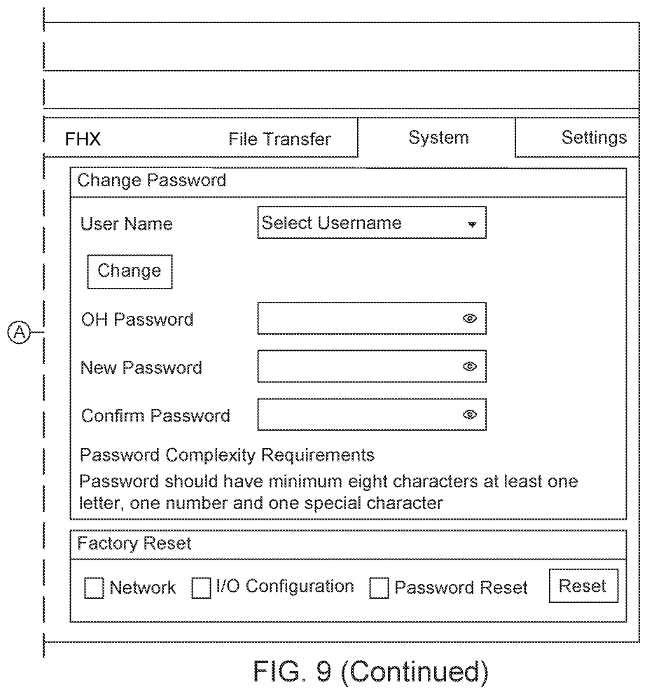

Referring to FIG. 9, an illustration of an example gateway system configuration interface 900 that can be provided by the gateway system 202 to the web browser 252 via the web application 228 is shown, in accordance with some aspects of the disclosure. As shown, the gateway system configuration interface 900 can be used to configure a variety of parameters associated with the gateway system 202. For example, the gateway system configuration interface 900 can be used to install a software upgrade (e.g., via a software upgrade file) on the gateway system 202. The gateway system configuration interface 900 can further be used to download a log detailing various events associated with the gateway system 202. The log can also be filtered by date (e.g., by entering a date range via the gateway system configuration interface 900) and/or by one or more specific keywords. The events can include any suitable events associated with the gateway system 202, including failure events, connection events, power events, etc. The gateway system configuration interface 900 can further be used to change the password associated with a given username that can be used to access the gateway system 202 via the web browser 252 (e.g., as entered via the login interface 600). Finally, the gateway system configuration interface 900 can be used to perform various types of resets (e.g., a factory reset) associated with the gateway system 202, including resetting network setting, resetting an input/output configuration (e.g., an input/output configuration file), and resetting a password associated with the gateway system 202.

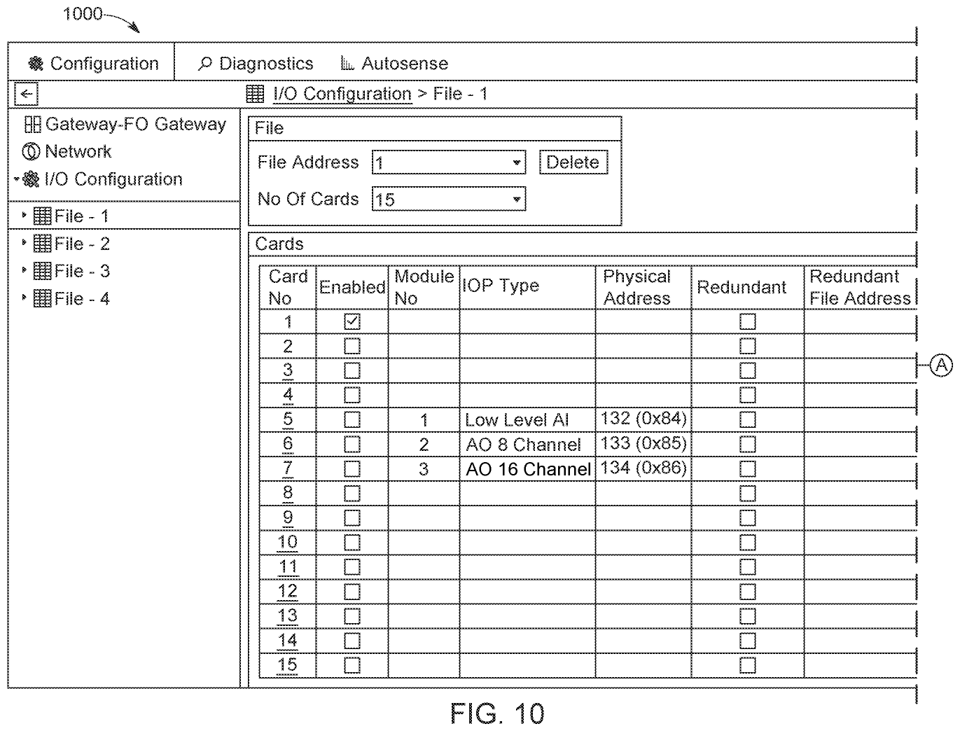

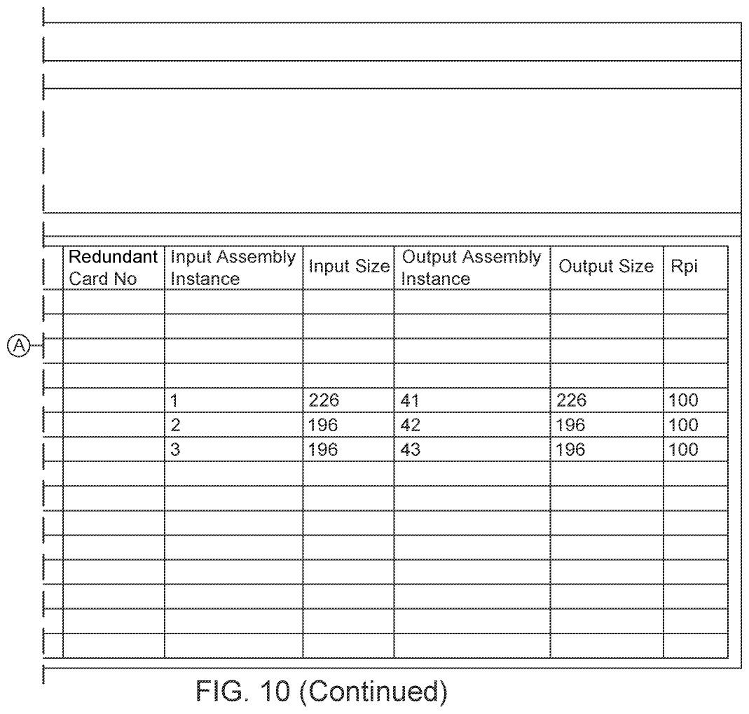

Referring to FIG. 10, an illustration of an example input/output file configuration interface 1000 that can be provided by the gateway system 202 to the web browser 252 via the web application 228 is shown, in accordance with some aspects of the disclosure. As shown, the input/output file configuration interface 1000 can be used to configure and view a variety of parameters associated with an input/output file used by the gateway system 202 to communicate with the I/O system 120 of the legacy distributed control system 100 and the controller system 214. In some examples, as noted above, the input/output file can be automatically generated by a cloud computing application to reduce the labor and time requirements of installing the gateway system 202. However, the input/output file can also be manually generated by a user via the web browser 252 if desired, and/or an auto-generated input/output file can be modified by a user via the web browser 252 if desired. Moreover, multiple input/output files associated with the gateway system 202 can be managed by the user via the web browser 252, where each file can be associated with one or more of the input/output cards 110, for example.

Via the input/output file configuration interface 1000, as shown in FIG. 10, the user can assign a file address to a selected input/output file as well as select a number of the input/output cards 110 that are associated with the particular input/output file. Then, the user can configure various parameters associated with the input/output cards 110 associated with the input/output file via the input/output file configuration interface 1000. For example, the user can enable and disable the input/output cards 110, assign a module number to the input/output cards 110, select a type associated with the input/output cards 110, configure a physical address associated with the input/output cards 110, assign the input/output cards 110 as redundant, configure a redundant physical address associated with the input/output cards 110, configure a redundant card number associated with the input/output cards 110, configure an input assembly instance associated with the input/output cards 110, configure an input size (e.g., in bits) associated with the input/output cards 110, configure an output assembly instance associated with the input/output cards 110, and configure an output size associated with the input/output cards 110.

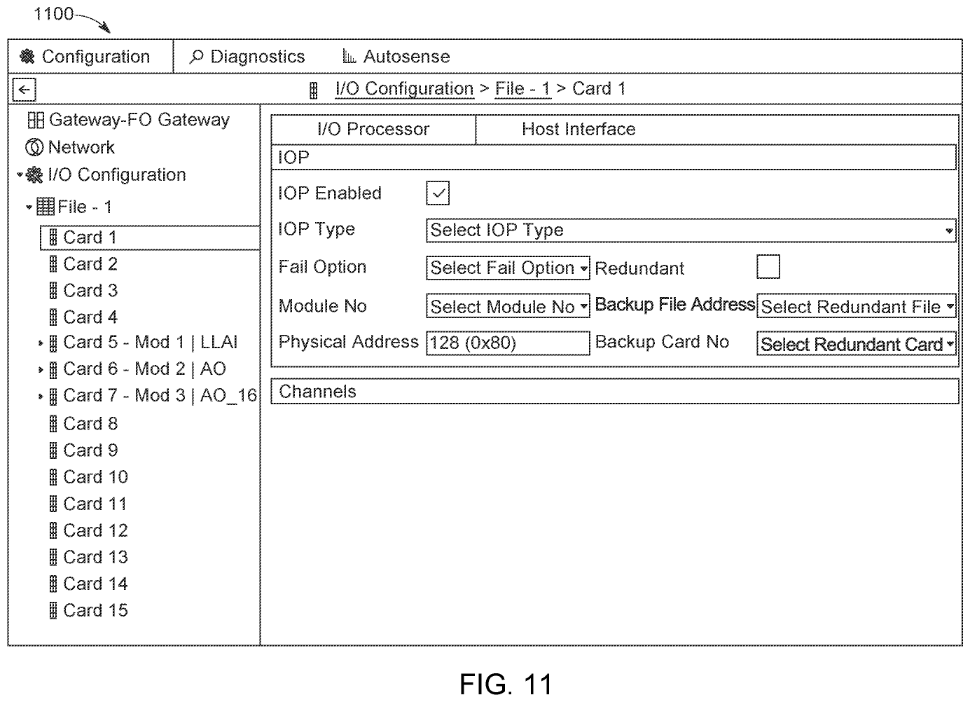

Referring to FIG. 11, an illustration of an example input/output card configuration interface 1100 that can be provided by the gateway system 202 to the web browser 252 via the web application 228 is shown, in accordance with some aspects of the disclosure. As shown, the input/output card configuration interface 1100 can be used to configure various parameters associated with a particular one of the input/output cards 110 contained in a particular input/output file. For example, via the input/output card configuration interface 1100, the user can enable or disable the input/output card, select a type associated with the input/output card, select a fail option for the input/output card, select a module number for the input/output card, assign the input/output card as a redundant input/output card, configure a physical address of the input/output card, configure a backup file address of the input/output card, and select a backup card number for the input/output card.

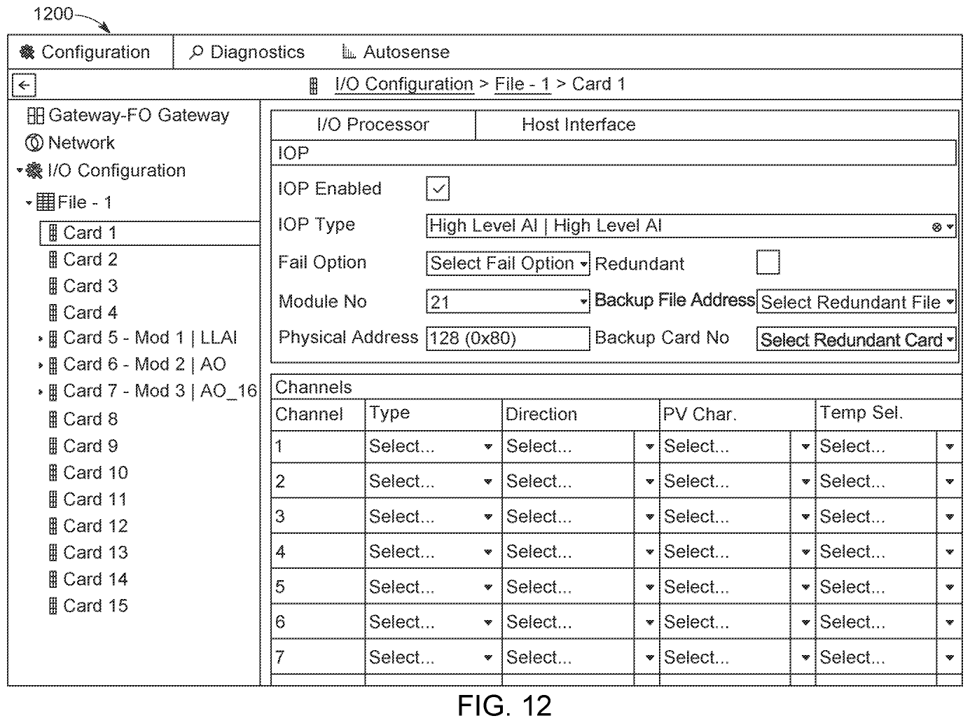

Referring to FIG. 12, an illustration of another example input/output card configuration interface 1200 that can be provided by the gateway system 202 to the web browser 252 via the web application 228 is shown, in accordance with some aspects of the disclosure. As shown, the input/output card configuration interface 1200 can be used to configure communication channels associated with a selected one of the input/output cards 110. For each communication channel, the user can use the input/output card configuration interface 1200 to select a type associated with the communication channel, select a direction associated with the communication channel, and select any other suitable parameters associated with the channel.

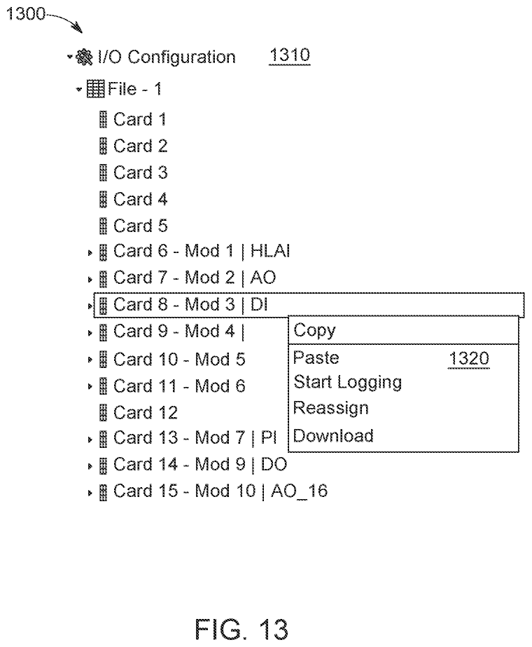

Referring to FIG. 13, an illustration of an example input/output card cloning interface 1300 that can be provided by the gateway system 202 to the web browser 252 via the web application 228 is shown, in accordance with some aspects of the disclosure. As shown, the input/output card cloning interface 1300 can be used to perform various functions that leverage an existing input/output card configuration (e.g., an auto-generated input/output card configuration, an input/output card configuration generated using the input/output card configuration interface 1100, an input/output card configuration generated using the input/output card configuration interface 1200, etc.). As shown in several of the example interfaces illustrated in FIGS. 6-21, the user interface presented to the user of the user device 250 via the web browser 252 can include a network tree 1310 that illustrates various logical and network relationships within the gateway system 202 in a hierarchal manner.

For example, as shown in FIG. 13, the network tree can show all of the input/output cards that are associated with a given input/output file. Then, for each of the input/output cards presented in the network tree 1310, the user can cause the gateway system 202 to launch an input/output card menu 1320 (e.g., by right-clicking on a particular input/output card included in the network tree 1310) to perform various functions that leverage the associated input/output card configuration. For example, via the input/output card menu 1320, the user can simply instruct the gateway system 202 to copy and paste selected input/output card configurations to clone input/output card configurations. Further, via the input/output card menu 1320, the user can cause the gateway system 202 to start an event logging process for selected input/output cards in the network tree 1310. Additionally, via the input/output card menu 1320, the user can easily reassign particular input/output cards to different slots (e.g., different to slots within the chassis 112 as a result of a backplane failure). This functionality can provide significant improvements in terms of facilitating control system upgrades relative to some previous approaches where reconfiguring input/output cards in different slots requires significant time and effort (e.g., hours of time) to reconfigure all of the necessary parameters associated with the slot change. Moreover, via the input/output card menu 1320, the user can download a given input/output card configuration (e.g., via an XML file, etc.) for various purposes.

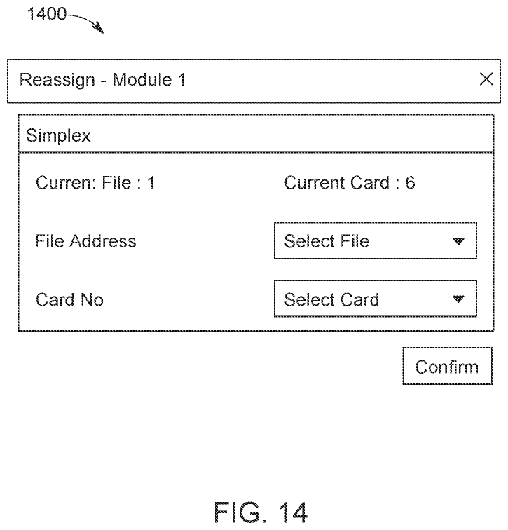

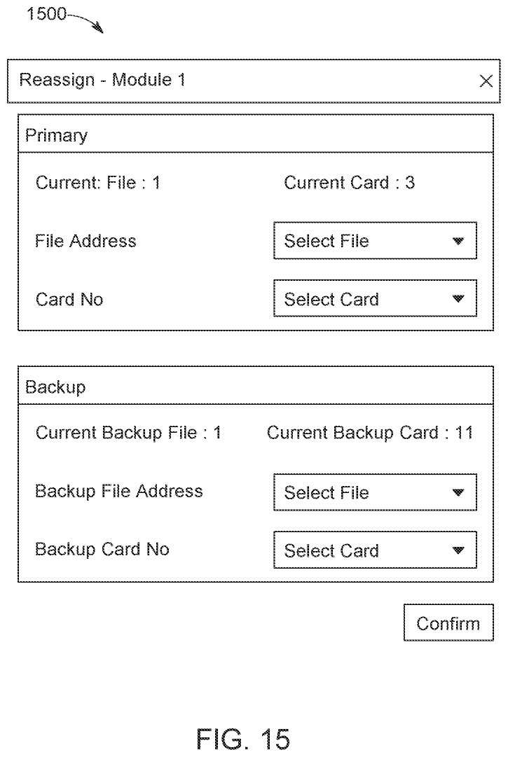

Referring to FIG. 14, an illustration of an example input/output card reassignment interface 1400 that can be provided by the gateway system 202 to the web browser 252 via the web application 228 is shown, in accordance with some aspects of the disclosure. As shown, the input/output card reassignment interface 1400 can be used to reassign an input/output card (e.g., one of the input/output cards 110) that is configured in a simplex configuration. Specifically, via the input/output card reassignment interface 1400, the user can move the selected input/output card between different input/output files and/or between different card numbers (e.g., card numbers associated with slots in the chassis 112). Referring to FIG. 15, an illustration of another example input/output card reassignment interface 1500 that can be provided by the gateway system 202 to the web browser 252 via the web application 228 is shown, in accordance with some aspects of the disclosure. As shown, the input/output card reassignment interface 1500 can be used to reassign an input/output card that is configured in a redundant configuration. Specifically, via the input/output card reassignment interface 1400, the user can move both the primary selected input/output card as well as the associated backup input/output card between different input/output files and/or between different card numbers.

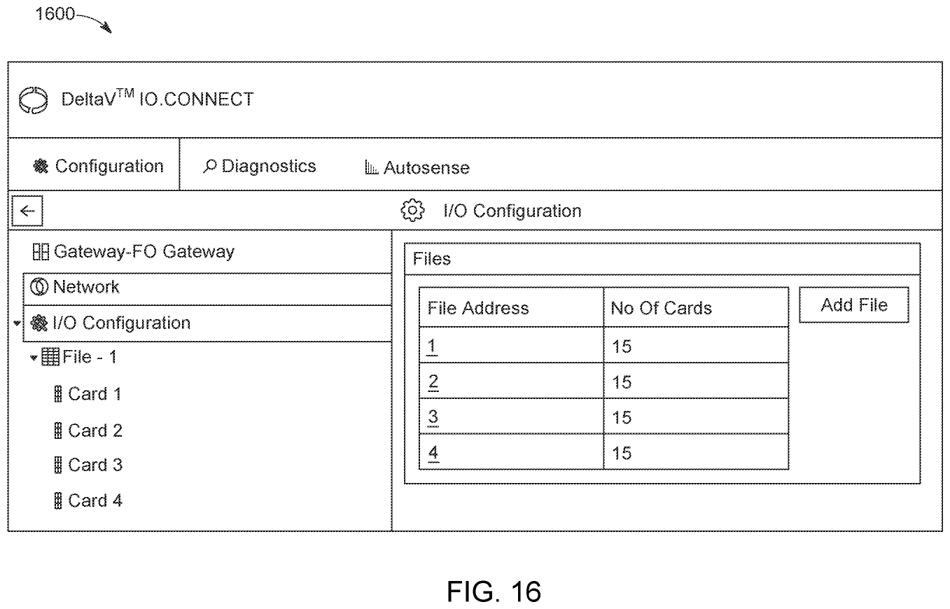

Referring to FIG. 16, an illustration of an input/out configuration overview interface 1600 that can be provided by the gateway system 202 to the web browser 252 via the web application 228 is shown, in accordance with some aspects of the disclosure. As shown, the user can use the input/output configuration overview interface 1600 can be used to view and/or modify any of the input/output files associated the gateway system 202 in the web application 228. For each of the input/output files associated the gateway system 202 in the web application 228, the input/output configuration overview interface 1600 presents a number of input/output cards and associated configurations that are contained within each of the input/output files. From the input/output configuration overview interface 1600, the user can add new input/output files if desired.

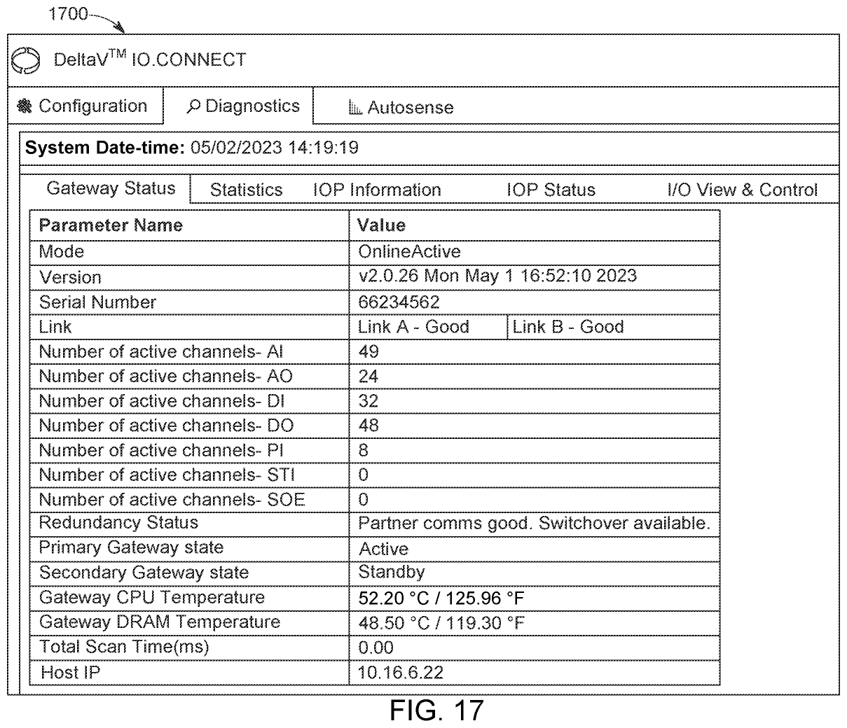

Referring to FIG. 17, an illustration of an example gateway status diagnostics interface 1700 that can be provided by the gateway system 202 to the web browser 252 via the web application 228 is shown, in accordance with some aspects of the disclosure. As shown, the user can use the gateway status diagnostics interface 1700 to view a variety of parameters associated with the gateway system 202, including a current mode, a current version, a serial number, a status of communication links (e.g., primary and secondary connections to the input/output system 120), a number of active communication channels of various types (e.g., analog input, analog output, digital input, digital output, etc.), a redundancy status, a state of the primary gateway device 202A, a state of the secondary gateway device 202B, a temperature of the processing circuitry 224, a temperature of the memory 222, a total scan time, and a host IP address. The parameters presented to the user via the gateway status diagnostics interface 1700 can provide efficient and effective troubleshooting of any problems that may arise pertaining to the functionality of the gateway system 202.

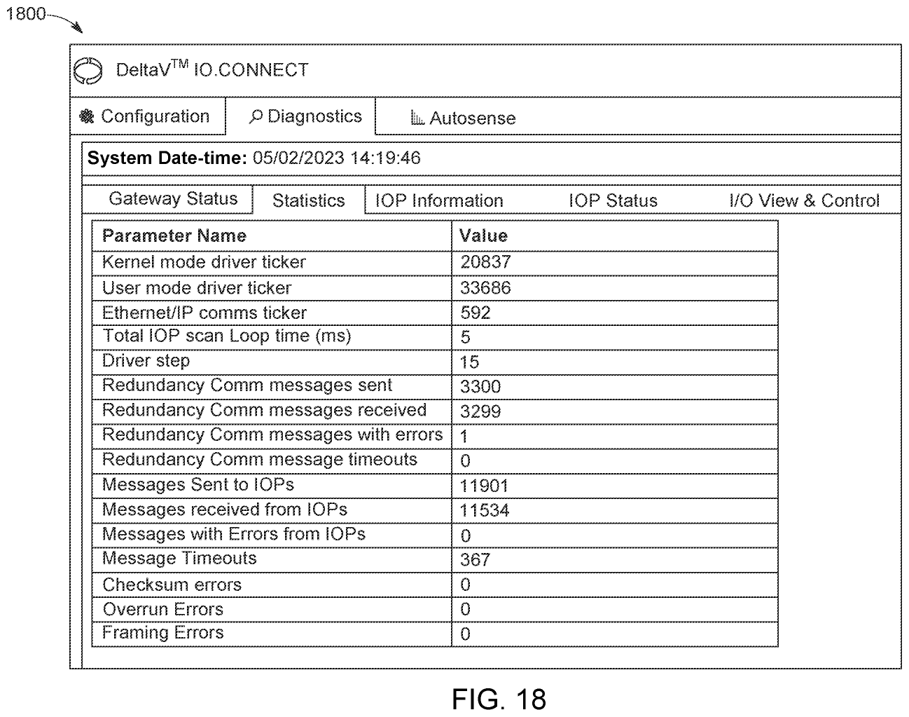

Referring to FIG. 18, an illustration of an example gateway statistics diagnostics interface 1800 that can be provided by the gateway system 202 to the web browser 252 via the web application 228 is shown, in accordance with some aspects of the disclosure. As shown, the user can use the gateway statistics diagnostics interface 1800 to view a variety of statistical data related to the performance of the gateway system 202 including data pertaining to messages sent, errors, and other statistical data. The statistical data that is presented to the user via the gateway statistics diagnostics interface 1800 can also provide efficient and effective troubleshooting of any problems that may arise pertaining to the functionality of the gateway system 202.

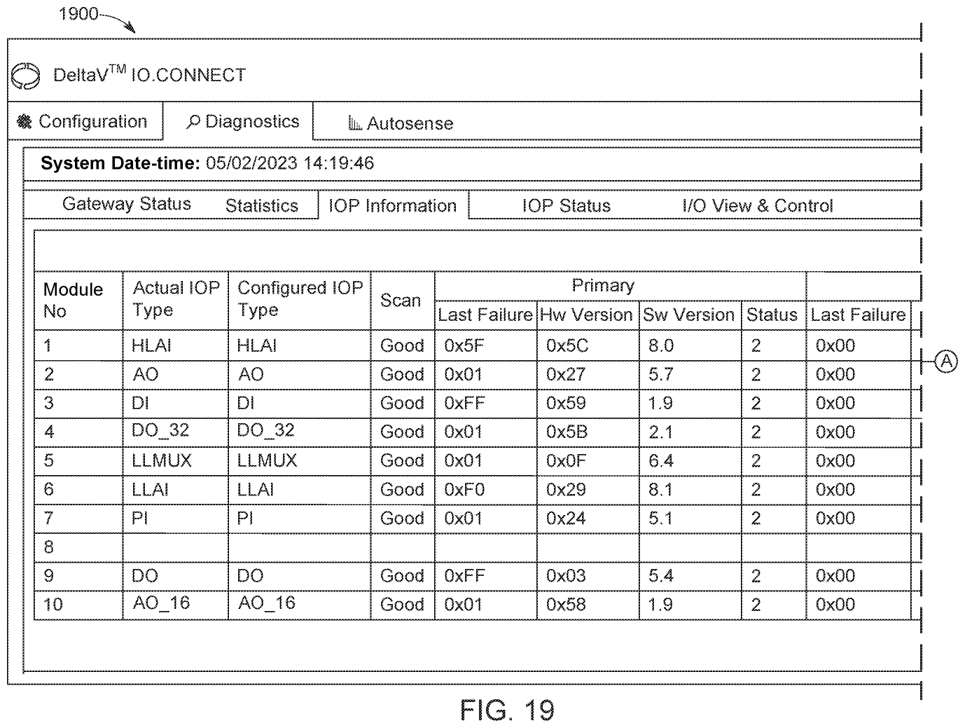

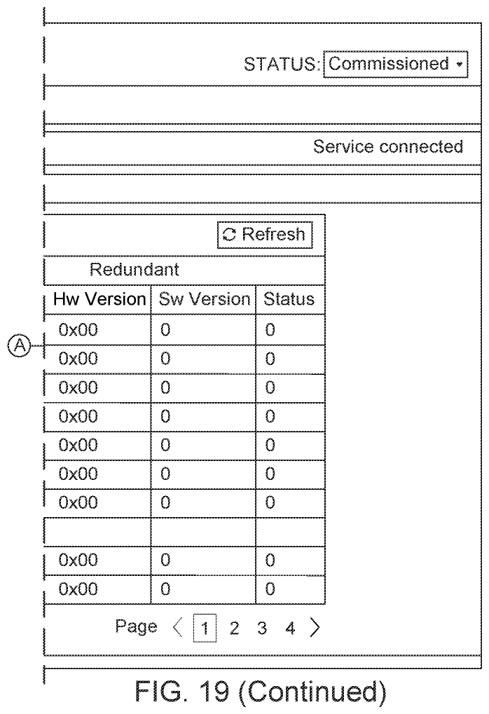

Referring to FIG. 19, an illustration of an example input/output card information diagnostics interface 1900 that can be provided by the gateway system 202 to the web browser 252 via the web application 228 is shown, in accordance with some aspects of the disclosure. As shown, the user can use the input/output card information diagnostics interface 1900 to view a variety of information related to configurations and historical events associated with input/output cards (e.g., the input/output cards 110) connected to the gateway system 202. For example, via the input/output card information diagnostics interface 1900, the user can view module (card) number information, card type information, scan status information, recent failure information, hardware version information, software information, and redundant backup card information. The informational data that is presented to the user via the input/output card information diagnostics interface 1900 can also provide efficient and effective troubleshooting of any problems that may arise pertaining to the functionality of the gateway system 202.

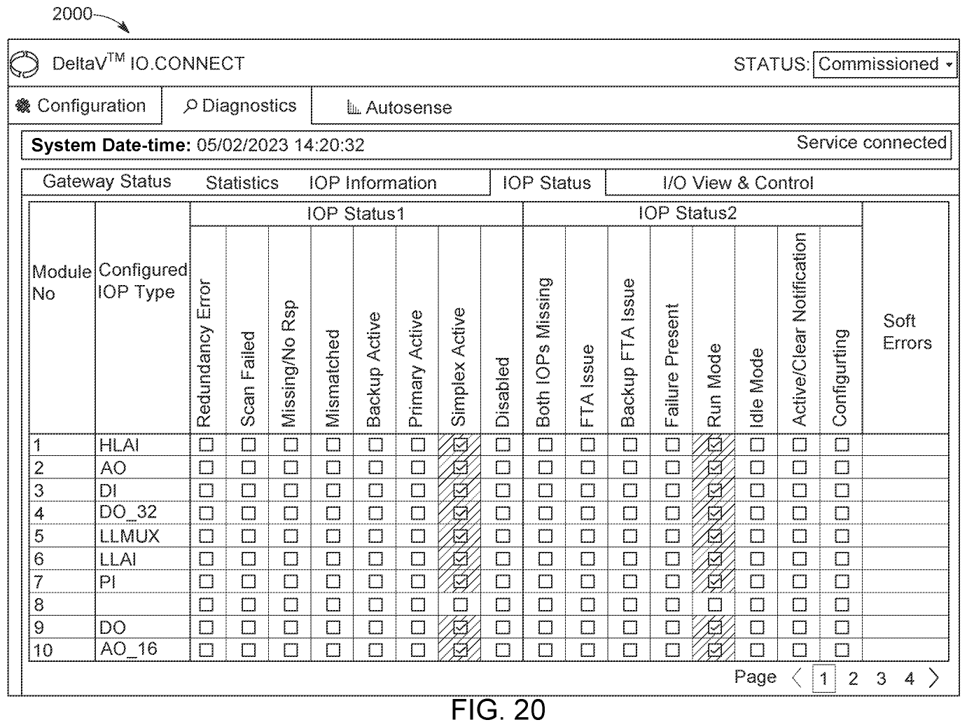

Referring to FIG. 20, an illustration of an example input/output card status diagnostics interface 2000 that can be provided by the gateway system 202 to the web browser 252 via the web application 228 is shown, in accordance with some aspects of the disclosure. As shown, via the input/output card status diagnostics interface 2000, the user can view (and potentially modify) a variety of status information associated with input/output cards connected to the gateway system 202. For example, the user can view redundancy status information, scan fail status information, communication error status information, mismatch error status information, primary active status information, backup active status information, simplex active status information, disabled status information, missing connection status information, field termination assembly error status information, operating mode status information, and notification status information via the input/output card status diagnostics interface 2000. The status data that is presented to the user via the input/output card status diagnostics interface 2000 can also provide efficient and effective troubleshooting of any problems that may arise pertaining to the functionality of the gateway system 202.

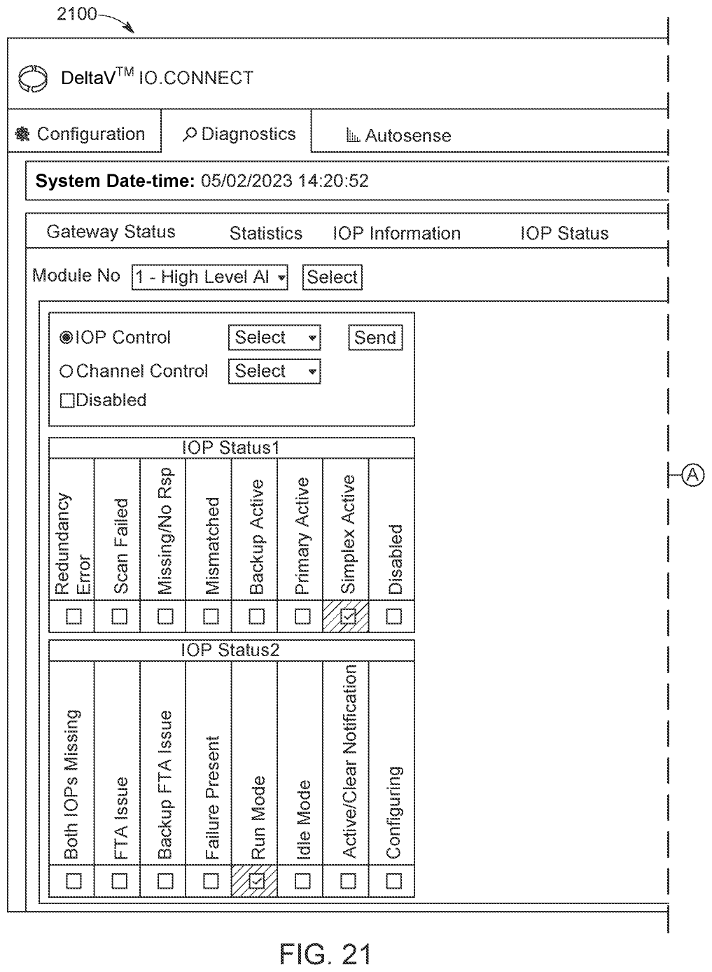

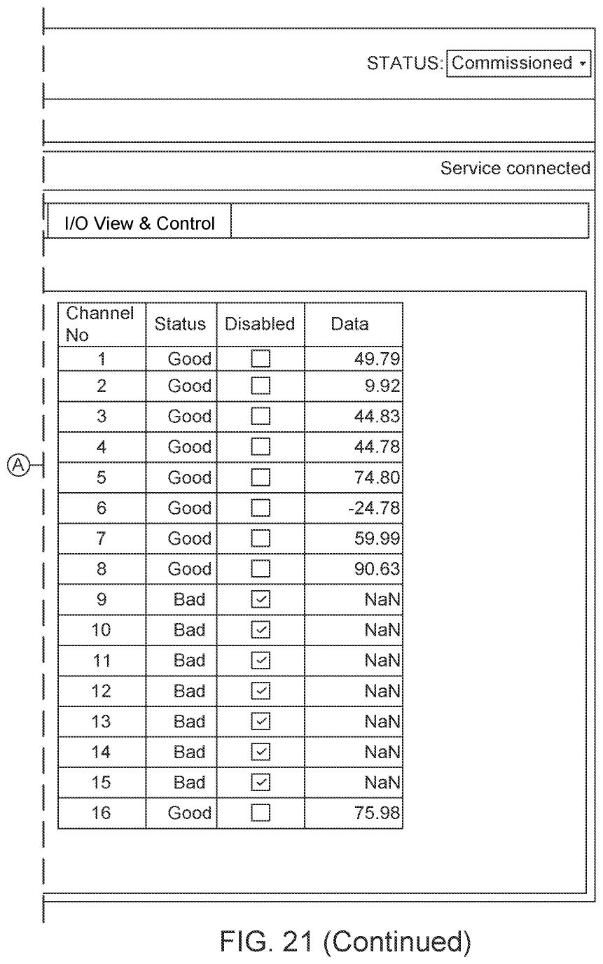

Referring to FIG. 21, an illustration of an example input/output card control diagnostics interface 2100 that can be provided by the gateway system 202 to the web browser 252 via the web application 228 is shown, in accordance with some aspects of the disclosure. As shown, the input/output card control diagnostics interface 2100 can be used to view and/or modify various control parameters associated with input/output cards connected to the gateway system 202. For example, the user can select and send one or more input/output control signals and/or one or more communication channel control signals to the input/output system 120 of the legacy distributed control system 100 via the input/output card control diagnostics interface 2100. Further, the user can enable and/or disable any particular individual communication channels associated with a given input/output card via the input/output card control diagnostics interface 2100. As shown, the input/output card control diagnostics interface 2100 can present status information associated with individual communication channels associated with a selected input/output card as well as data being received via the individual communication channels associated with the selected input/output card via the input/output card control diagnostics interface 2100 to assist the user in determining control actions to take with respect to the individual communication channels associated with the selected input/output card. The channel information as well as the ability to perform control actions provided by the input/output card control diagnostics interface 2100 can also provide efficient and effective troubleshooting of any problems that may arise pertaining to the functionality of the gateway system 202.

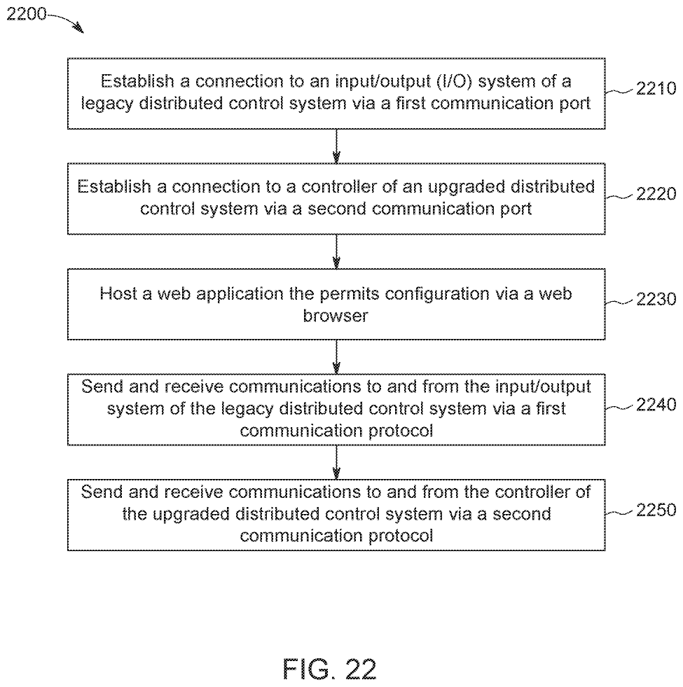

Referring to FIG. 22, a flow diagram illustrating an example process 2200 for integrating an input/output system of a first distributed control system into a second distributed control system, in accordance with some aspect of the disclosure. For example, the process 2200 can be performed by the gateway system 202 to integrate the input the input/output system 120 of the legacy distributed control system 100 into the upgraded distributed control system 200. Due to the ease of configurability provided by the web application 228 that permits configuration of the gateway system 202 via the web browser 252, the process 2200 can be used to provide significant advantages in terms of facilitating control system upgrades. Moreover, due to the redundancy provided by using both the primary gateway device 202A and the secondary gateway device 202B, improved reliability for critical process applications can also be provided.

The process 2200 is shown to include establishing a first connection to an input/output (I/O) system of a legacy distributed control system via a first communications port (2210). For example, the process 2200 can include establishing the first connection between the gateway system 202 and the input/output system 120 of the legacy distributed control system 100 via the communications and power interfaces 230 (e.g., using the specifically designed input/output link cable 260). The process 2200 can include establishing the first connection between the gateway system 202 and the input/output system 120 of the legacy distributed control system 100 by executing a handshaking process (e.g., sending and/or receiving one or more handshaking signals), for example, among other suitable approaches and combinations thereof. The process 2200 is also shown to include establishing a second connection to a controller of an upgraded distributed control system via a second communication port (2220). For example, the process 2200 can include establishing the second connection between the gateway system 202 and the controller system 214 also via the communications and power interfaces 230 (e.g., via one or more Ethernet ports). The process 2200 can also include establishing the second connection between the gateway system 202 and the and the controller system 214 by executing a handshaking process, for example, among other suitable approaches to establishing the second connection, and various combinations thereof. Moreover, the process 2200 can include establishing the redundant communications link 202C between the primary gateway device 202A and the secondary gateway device 202B. The redundant communication link 202C can be used to establish and maintain database synchronization communications between the primary gateway device 202A and the secondary gateway device 202B. This feature allows users to replace a broken gateway device with a new, replacement gateway device. Once the redundancy link 202C is created with the new gateway device, the process 2200 can include automatically synchronizing and commissioning the new gateway device as the backup device in the gateway system 202.

The process 2200 is further shown to include hosting a web application that permits configuration via a web browser (2230). Hosting the web application may include execution of the web application 228 by the gateway system 202 (e.g., by the processing circuitry 224 of the primary gateway device 202A). Such execution can cause, among other things, the gateway system 202 to transmit data and information (e.g., via communications and power interfaces 230) to a user device (e.g., the user device 250) for rendering of one or more graphical user interfaces on the user device (e.g., via the web browser 252). Such execution can further cause the gateway system 202 to receive configuration data from the user device via the web browser. For example, the process 2200 can include hosting the web application 228 via the gateway system 202 such that the web application 228 permits a configuration of the gateway system 202 via the web browser 252. As detailed throughout the disclosure, the configuration via the web browser 252 can include a wide variety of parameters and configurations used by the gateway system 202 to facilitate the integration of the input/output system 120 of the legacy distributed control system 100 into the upgraded distributed control system 200. For example, any of the interfaces shown in FIGS. 6-21 can be used to configure the gateway system 202 via the web browser 252.

The process 2200 is further shown to include sending and/or receiving communications to and/or from the input/output system of the legacy distributed control system via a first communication protocol (2240). For example, the gateway system 202 can send and receive communications with the input/output system 120 of the legacy distributed control system 100 via the first communication protocol. The gateway system 202 can send requests to the input/output system 120 (e.g., to one or more of the specific input/output cards 110) for data (e.g., temperature data, pressure data, etc.) at periodic intervals based on the configuration received at 2330 via the web browser 252. The input/output system 120 can also send data to the gateways system 202 at periodic intervals as per the established first connection at 2210 such that the gateways system 202 may not necessarily need to explicitly request data from the input/output system 120. The gateway system 202 can send and receive communications to and/or from the input/output system 120 of the legacy distributed control system 100 via various types of serial communications protocols, for example, such as by using the input/output link cable 260 and using a serial advanced technology attachment (SATA) protocol. Other types of serial communication protocols (e.g., universal asynchronous receiver-transmitter (UART), Universal Serial Bus (USB), etc.) can be used, in addition to other types of communication protocols beyond serial protocols.

Finally, the process 2200 is shown to include sending and/or receiving communications to and/or from the controller of the upgraded distributed control system via a second communications protocol (2250). For example, the gateway system 202 can send and receive communications to and from the controller system 214 using various types of Ethernet protocols, among other types of communication protocols including serial protocols, wireless protocols (e.g., Wi-Fi, cellular, etc.), native (closed) protocols, an/or other protocols that may be used by the upgraded distributed control system 200. The process 2200 can include translating the data received from the input/output system 120 of the legacy distributed control system 100 at 2240, for example according to a mapping that is defined by the configuration received at 2330 via the web browser 252. The mapping can be used by the gateway system 202 to translate a temperature value received from the input/output system 120 to a format that is recognizable by the controller system 214 and the upgraded distributed control system 200 more broadly. Then, using the recognized temperature value received from the gateway system 202, the controller system 214 can execute one or more control algorithms to control the equipment 270 based on the recognized temperature value received from the gateway system 202. It will be appreciated that, while the steps of the process 2200 are shown in a particular order in FIG. 22, the process 2200 may not include all steps shown, may include additional steps, or may include the steps in a different order.

This disclosure is not limited in its application to the details of construction and the arrangement of components set forth in this description or illustrated in the accompanying drawings. The disclosure is capable of other embodiments and of being practiced or of being carried out in various ways. Also, it is to be understood that the phraseology and terminology used herein is for the purpose of description and should not be regarded as limiting. The use of “including”, “comprising”, “containing”, or “having” and variations thereof herein is meant to encompass the items listed thereafter and equivalents thereof as well as additional items. Unless specified or limited otherwise, the terms “mounted”, “connected”, “supported”, “coupled”, and different variations thereof are used broadly and encompass both direct and indirect mountings, connections, supports, and couplings. Further, “connected” and “coupled” are not restricted to physical or mechanical connections or couplings.

Some embodiments, including computerized implementations of methods according to the disclosure, can be implemented as a system, method, apparatus, or article of manufacture using standard programming or engineering techniques to produce software, firmware, hardware, or any combination thereof to control a processor device (e.g., a serial or parallel processor chip, a single- or multi-core chip, a microprocessor, a field programmable gate array, any variety of combinations of a control unit, arithmetic logic unit, and processor register, and so on), a computer (e.g., a processor device operatively coupled to a memory), or another electronically operated controller to implement aspects detailed herein. Accordingly, for example, embodiments of the disclosure can be implemented as a set of instructions, tangibly embodied on a non-transitory computer-readable media, such that a processor device can implement the instructions based upon reading the instructions from the computer-readable media.

Some embodiments of the disclosure can include (or utilize) a control device such as, for example, an automation device, a computer including various computer hardware, software, firmware, and so on, consistent with the discussion below. As specific examples, a control device can include a processor, a microcontroller, a field-programmable gate array, a programmable logic controller, logic gates, etc., and other typical components that are known in the art for implementation of appropriate functionality (e.g., memory, communication systems, power sources, user interfaces and other inputs, etc.). Also, functions performed by multiple components may be consolidated and performed by a single component. Similarly, the functions described herein as being performed by one component may be performed by multiple components in a distributed manner. Additionally, a component described as performing particular functionality may also perform additional functionality not described herein. For example, a device or structure that is “configured” in a certain way is configured in at least that way, but may also be configured in ways that are not listed.

The term “article of manufacture” as used herein is intended to encompass a computer program accessible from any computer-readable device, carrier (e.g., non-transitory signals), or media (e.g., non-transitory media). For example, non-transitory computer-readable media can include but are not limited to magnetic storage devices (e.g., hard disk, floppy disk, magnetic strips, and so on), optical disks (e.g., compact disk (“CD”), digital versatile disk (“DVD'”), and so on), smart cards, and flash memory devices (e.g., card, stick, and so on). Additionally, it should be appreciated that a carrier wave can be employed to carry computer-readable electronic data such as, for example, those used in transmitting and receiving electronic mail or in accessing a network such as, for example, the Internet or a local area network (“LAN”). Those skilled in the art will recognize that many modifications may be made to these configurations without departing from the scope or spirit of the claimed subject matter.

Certain operations of methods according to the disclosure, or of systems executing those methods, may be represented schematically in the figures or otherwise discussed herein. Unless otherwise specified or limited, representation in the figures of particular operations in particular spatial order may not necessarily require those operations to be executed in a particular sequence corresponding to the particular spatial order. Correspondingly, certain operations represented in the figures, or otherwise disclosed herein, can be executed in different orders than are expressly illustrated or described, as appropriate for particular embodiments of the disclosure. Further, in some embodiments, certain operations can be executed in parallel, including by dedicated parallel processing devices, or separate computing devices configured to interoperate as part of a large system.

As used herein in the context of computer implementation, unless otherwise specified or limited, the terms “component,” “system,” “module,” and the like are intended to encompass part or all of computer-related systems that include hardware, software, a combination of hardware and software, or software in execution. For example, a component may be, but is not limited to being, a processor device, a process being executed (or executable) by a processor device, an object, an executable, a thread of execution, a computer program, or a computer. By way of illustration, both an application running on a computer and the computer can be a component. One or more components (or system, module, and so on) may reside within a process or thread of execution, may be localized on one computer, may be distributed between two or more computers or other processor devices, or may be included within another component (or system, module, and so on).

In some implementations, devices or systems disclosed herein can be utilized or installed using methods embodying aspects of the disclosure. Correspondingly, description herein of particular features, capabilities, or intended purposes of a device or system is generally intended to inherently include disclosure of a method of using such features for the intended purposes, a method of implementing such capabilities, and a method of installing disclosed (or otherwise known) components to support these purposes or capabilities. Similarly, unless otherwise indicated or limited, discussion herein of any method of manufacturing or using a particular device or system, including installing the device or system, is intended to inherently include disclosure, as embodiments of the disclosure, of the utilized features and implemented capabilities of such device or system.

As used herein, unless otherwise defined or limited, ordinal numbers are used herein for convenience of reference based generally on the order in which particular components are presented for the relevant part of the disclosure. In this regard, for example, designations such as, for example, “first,” “second,” etc., generally indicate only the order in which the relevant component is introduced for discussion and generally do not indicate or require a particular spatial arrangement, functional or structural primacy or order.

As used herein, unless otherwise defined or limited, directional terms are used for convenience of reference for discussion of particular figures or examples. For example, references to downward (or other) directions or top (or other) positions may be used to discuss aspects of a particular example or figure, but do not necessarily require similar orientation or geometry in all installations or configurations.

As used herein, unless otherwise defined or limited, the phase “and/or” used with two or more items is intended to cover or include the items individually and the items together. For example, a device having “a and/or b” is intended to cover or include: a device having a (but not b); a device having b (but not a); and a device having both a and b.

This discussion is presented to enable a person skilled in the art to make and use embodiments of the disclosure. Various modifications to the illustrated examples will be readily apparent to those skilled in the art, and the generic principles herein can be applied to other examples and applications without departing from the principles disclosed herein. Thus, embodiments of the disclosure are not intended to be limited to embodiments shown, but are to be accorded the widest scope consistent with the principles and features disclosed herein and the claims below. The provided detailed description is to be read with reference to the figures, in which like elements in different figures have like reference numerals. The figures, which are not necessarily to scale, depict selected examples and are not intended to limit the scope of the disclosure. Skilled artisans will recognize the examples provided herein have many useful alternatives and fall within the scope of the disclosure.

While the invention herein disclosed has been described in terms of specific embodiments and applications thereof, numerous modifications and variations could be made thereto by those skilled in the art without departing from the scope of the invention set forth in the claims.

1. A gateway device, comprising:
a first communication port that is configured to be connected to an input/output system communication bus of a first distributed control system;
a second communication port that is configured to be connected to a controller of a second distributed control system;
a processor; and
a memory that includes program code for causing the processor to:
send and receive communications to and from the input/output system via a first communication protocol;
send and receive communications to and from the controller via a second protocol that is different from the first protocol; and
host a web application that permits configuration of the gateway device via a web browser.

2. The gateway device of claim 1, wherein the program code for causing the processor to host the web application includes program code for causing the processor to generate a configuration file that is downloadable to the second distributed control system.

3. The gateway device of claim 1, wherein:
the memory includes program code for causing the processor to receive a configuration file from the web browser; and
the memory includes program code for causing the processor to use the configuration file to send and receive the communications to and from the input/output system in accordance with the configuration file.

4. The gateway device of claim 1, wherein:
the memory includes program code for causing the processor to receive a software update for the gateway device from the web browser; and
the memory includes program code for causing the processor to install the software update for the gateway device based on an instruction received from the web browser.

5. The gateway device of claim 1, wherein:
the memory includes program code for causing the processor to receive an instruction from the web browser for reassigning an input/output card of the input/output system to a second location in the input/output system from a first location in the input/output system; and
the memory includes program code for causing the processor to reassign the input/output card in accordance with the instruction received from the web browser.

6. The gateway device of claim 5, wherein:
the memory includes program code for causing the processor to receive a second instruction from the web browser for reassigning a backup input/output card of the input/output system that is associated with the input/output card of the input/output system to a fourth location in the input/output system from a third location in the input/output system; and
the memory includes program code for causing the processor to reassign the backup input/output card in accordance with the second instruction received from the web browser.

7. The gateway device of claim 1, wherein:
the memory includes program code for causing the processor to receive a configuration for a second input/output card of the input/output system from the web browser; and
the configuration for the second input/output card of the input/output system is a clone of a first input/output card of the input/output system.

8. The gateway device of claim 1, wherein:
the memory includes program code for causing the processor to receive an instruction from the web browser for disabling an input/output card of the input/output system; and
the memory includes program code for causing the processor to cease the communications to and from the disabled input/output card based on the instruction.

9. The gateway device of claim 1, wherein:
the memory includes program code for causing the processor to receive an instruction from the web browser for disabling a communication channel associated with an input/output card of the input/output system; and
the memory includes program code for causing the processor to cease the communications to and from the disabled communication channel based on the instruction.

10. A gateway system, comprising:
a primary gateway device comprising a first communications interface;
a redundant secondary gateway device comprising a second communications interface;
processing circuitry; and
memory comprising machine-readable instructions that, when executed by the processing circuitry, cause the processing circuitry to:
establish a first connection to a primary communication bus of an input/output system of a first distributed control system via the first communications interface of the primary gateway device;
establish a second connection to a redundant secondary communication bus of the input/output system of the first distributed control system via the second communications interface;
host a web application that permits configuration of the gateway system via a web browser;
receive, from the web browser, a configuration file for the gateway system;
receive communications from the input/output system of the first distributed control system via the first communications interface and the second communications interface in accordance with the configuration file;
send the communications from the input/output system of the first distributed control system to a controller system of a second distributed control system such that the controller system can use the communications from the input/output system of the first distributed control system to control equipment in the second distributed control system based on the communications from the input/output system of the first distributed control system.

11. The gateway system of claim 10, wherein the machine-readable instructions, when executed by the processing circuitry, cause the processing circuitry to:
receive an instruction from the web browser for reassigning an input/output card of the input/output system to a second location in the input/output system from a first location in the input/output system; and
reassign the input/output card in accordance with the instruction received from the web browser.

12. The gateway system of claim 10, wherein the machine-readable instructions, when executed by the processing circuitry, cause the processing circuitry to:
receive first network configuration data comprising a first Internet Protocol (IP) address and a first subnet mask for the primary gateway device from the web browser;
receive second network configuration data comprising a second IP address and a second subnet mask for the redundant secondary gateway device gateway device from the web browser; and
send the communications from the input/output system of the first distributed control system to a controller system of a second distributed control system based on the first network configuration data and the second network configuration data.

13. The gateway system of claim 12, wherein the machine-readable instructions, when executed by the processing circuitry, cause the processing circuitry to require that a third octet of the second IP address is incremented by one relative to a third octet of the first IP address.

14. The gateway system of claim 10, wherein the machine-readable instructions, when executed by the processing circuitry, cause the processing circuitry to:
receive an instruction from the web browser for reassigning an input/output card of the input/output system to a second location in the input/output system from a first location in the input/output system; and
reassign the input/output card in accordance with the instruction received from the web browser.

15. The gateway system of claim 10, wherein the machine-readable instructions, when executed by the processing circuitry, cause the processing circuitry to:
receive an instruction from the web browser for changing a channel type associated with a communication channel of an input/output card of the input/output system; and
change the channel type associated with the communication channel of the input/output card based on the instruction.

16. A method for integrating an input/output system of a first distributed control system into a second distributed control system, the method comprising:
establishing a first connection to the input/output system of the first distributed control system via a first communication port of a gateway system;
establishing a second connection to a controller system of the second distributed control system via a second communication port of the gateway system;
hosting, by the gateway system, a web application that permits a configuration of the gateway system via a web browser;
receiving communications from the input/output system of the first distributed control system via the first communication port of the gateway system based on the configuration of the gateway system via the web browser; and
sending the communications received from the input/output system of the first distributed control system to the controller system of the second distributed control system via the second communication port of the gateway system based on the configuration of the gateway system via the web browser such that the controller system can use the communications from the input/output system of the first distributed control system to control equipment in the second distributed control system based on the communications from the input/output system of the first distributed control system.

17. The method of claim 16, comprising:
receiving an instruction from the web browser for reassigning an input/output card of the input/output system to a second location in the input/output system from a first location in the input/output system; and
reassigning the input/output card in accordance with the instruction received from the web browser.

18. The method of claim 17, wherein:
receiving a second instruction from the web browser for reassigning a backup input/output card of the input/output system that is associated with the input/output card to a fourth location in the input/output system from a third location in the input/output system; and
reassigning the backup input/output card to the fourth location in accordance with the second instruction received from the web browser.

19. The method of claim 16, comprising:
receiving an instruction from the web browser for disabling an input/output card of the input/output system; and
ceasing communications from the disabled input/output card of the input/output system based on the instruction.

20. The method of claim 16, comprising:
receiving an instruction from the web browser for disabling a communication channel of an input/output card of the input/output system; and
ceasing communications from the disabled communication channel of the input/output card based on the instruction.
